(19) United States
(12) Patent Application Publication
(10) Pub. No.: US 2003/0043087 A1
(43) Pub. Date: Mar. 6, 2003

(54) Display screen

(76) Inventor: Hyun Dae Kim, Olmsted Township, OH (US)

Correspondence Address: SAND & SEBOLT, 4801 DRESSLER RD., N.W., SUITE 194, CANTON, OH, 44718, US

(21) Appl. No.: 10/231,746

(22) Filed: Aug. 28, 2002

Related U.S. Application Data
(60) Provisional application No. 60/316,072, filed on Aug. 29, 2001.

(51) Int. Cl. G09G 5/00

(52) U.S. Cl. 345/1.1

(57) ABSTRACT

A monitor or display screen is disclosed, the display screen including a central screen with a width and lateral sides. A first lateral screen is pivotally attached to one of the lateral sides of the central screen. A second lateral screen is pivotally attached to the other of the lateral sides of the central screen. First and second screens are of substantially the same width as central screen. The pivotal attachment of the first and second screens may include an arc-shaped support structure that is hingedly attached at one end to the central screen. The support structure defines a plurality of slots therein and the structure is attached to the first or second screens with a plurality of bolts that engage in the slots. The bolts are adapted to slide in the slots thereby allowing for adjustment of the first and second screens relative to the central screen. First and second screens may be folded one-on-top-of-the-other over the central screen so that a compact unit is formed. Central screen defines at least one bore and a peg is movably retained in the bore and is adapted for axial movement within the bore. The central screen hinges are mounted on the pegs so that second screen can be raised relative to the central screen and first screen combination to allow for easier folding of the unit.

### BACKGROUND OF THE INVENTION

1. Technical Field

This invention generally relates to electronic computer. More particularly, the invention relates to displays or monitors for electronic computers, video terminals or games or other similar machines. Specifically, the invention relates to a display screen or monitor that includes a plurality of screens that are hinged together.

1. Background Information

Computers and video terminals or games are conventionally equipped with a monitor for the display of information. One disadvantage of conventional monitors is that the size of the display is usually limited in width. While oversized monitors are available, they usually take up considerable amounts of space and may be difficult to transport. The disadvantage in size is especially noticeable in devices such as hand-held personal computers or gaming devices. These devices are useful because they are small and compact, can be easily transported and can be held in one hand by the user. All these advantages in the device result in the disadvantage of the provision of a very small monitor.

A need, therefore, exists for a computer monitor having an increased surface area, but which is also compact to reduce the amount of space required for its storage and to facilitate its transportation.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective front view of a computer monitor system in accordance with the present invention, the computer having vertically adjustable multiple screens;

FIG. 2 is a partial rear view of the computer monitor system of FIG. 1 with the connection between two of the screens being more clearly illustrated;

FIG. 3 is a top view of a computer monitor system in accordance with the present invention;

FIG. 4 is a side view of the connection between screens on line 4-4, FIG. 2;

FIG. 5 is a front view of a second embodiment of a computer monitor system in accordance with the present invention, illustrating the use of a simple hinge to allow the screens to be folded one on top of the other;

FIG. 6 is a bottom view of the computer monitor system of FIG. 5 showing the screens being folded, one on top of the other;

FIG. 7 is a bottom view of the computer monitor system of FIG. 5 showing the screens in a completely folded position;

FIG. 8 is a third embodiment of a computer monitor system in accordance with the present invention, where the screens are shown as both vertically and horizontally adjustable;

FIG. 9 is a bottom view of the computer monitor system of FIG. 8 showing how the screens may be folded with one screen on top of the other;

FIG. 10 is a side view of the computer monitor system of FIG. 8 showing how the screens may be both vertically and horizontally adjusted relative to the main screen;

FIG. 11 is a perspective view of a palm-sized computer or hand-held game computer showing how the screens can be folded into a compact unit;

FIG. 12 shows a perspective view of the palm-sized computer of FIG. 11 showing how an adjustable multiple screen multiple system may be utilized on a hand-held device.

### DETAILED DESCRIPTION OF THE INVENTION

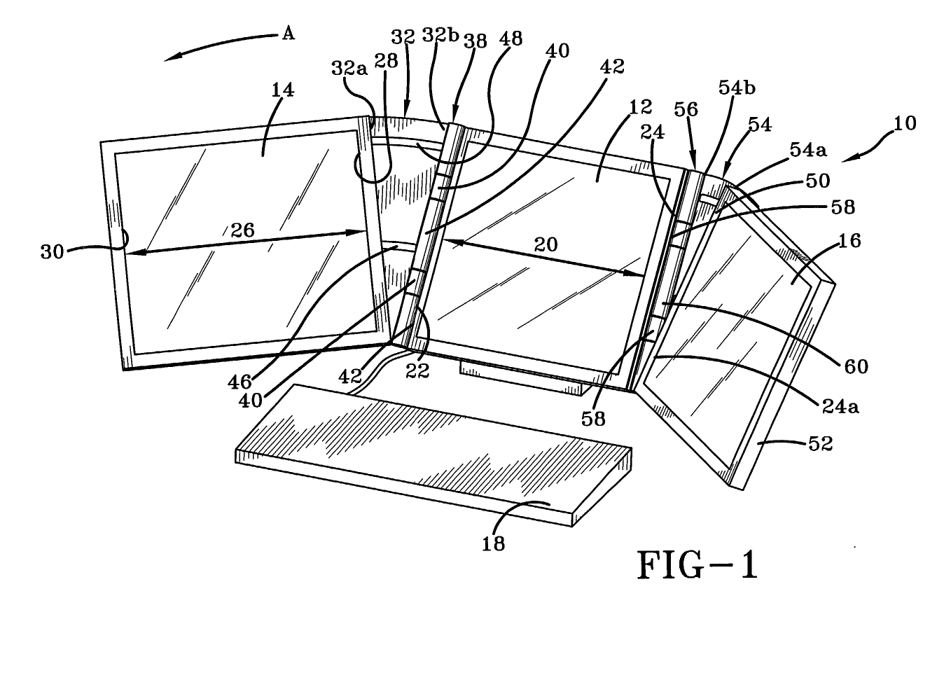

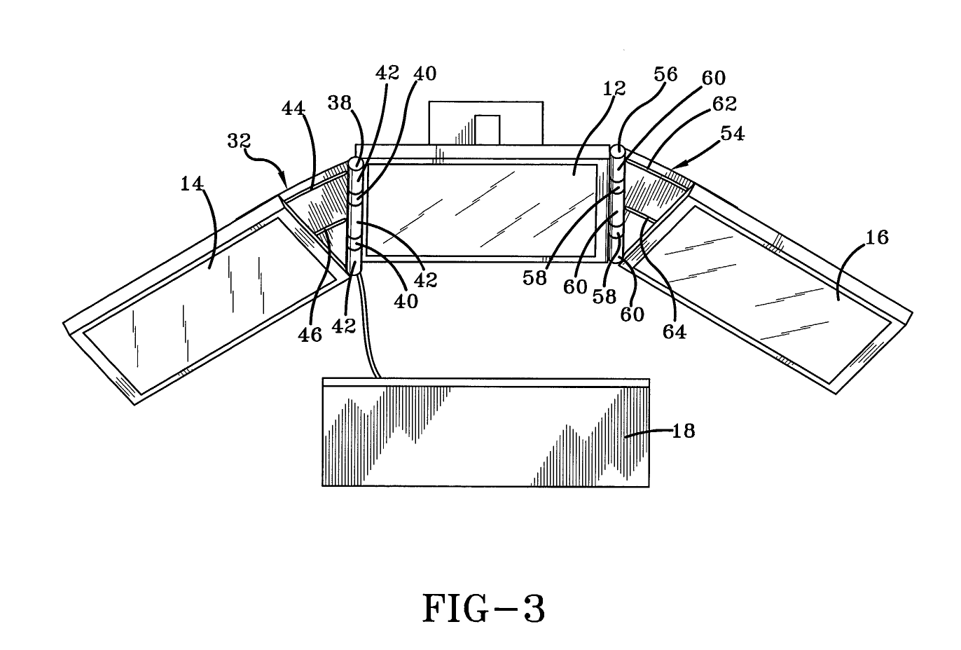

Referring to FIGS. 1-4, there is shown a computer system in accordance with the present invention, generally referred to by the number 10. Computer system 10 includes a central screen 12, first and second lateral screens 14, 16 and a keyboard 18. Keyboard or input device 18 may be separate from central screen 12 as is shown in FIG. 1, or, it may be hingedly connected to central screen 12 as in a laptop computer or it may be connected in any other suitable manner to computer system 10. (For clarity, an information storage unit has not been shown in FIGS. 1-10 as it has no bearing on the present invention.)

Central screen 12 has a width 20 and opposing first and second lateral sides 22, 24. First lateral side 22 of central screen 12 is provided with at least a first hinge cylinder 42. Second lateral side 24 of central screen 12 is provided with at least a third hinge cylinder 60.

First lateral screen 14 is adjacent first side 22 of central screen 12. First screen 14 has a width 26 that is approximately equal in width to that of central screen 12. First screen 14 has an inner lateral side 28 and an outer lateral side 30. First screen 14 is connected to central screen 12 by an arc-shaped supporting structure 32. Supporting structure 32 has a first end 32a and a second end 32b. Second end 32b has at least a second hinge cylinder 40 formed therein. First end 32a of supporting structure 32 is releasably connected to the back 34 of first screen 14 by way of bolts 36a, 36b or some other suitable means. Second hinge cylinders 40 of second end 32b of supporting structure 32 are pivotally connected to first hinge cylinders 42 of central screen 12 by elongated rod 38. Once connected togther, hinges 40, 42 can be rotated in much the same way as those used to connect a keyboard to a monitor in presently known laptop computers.

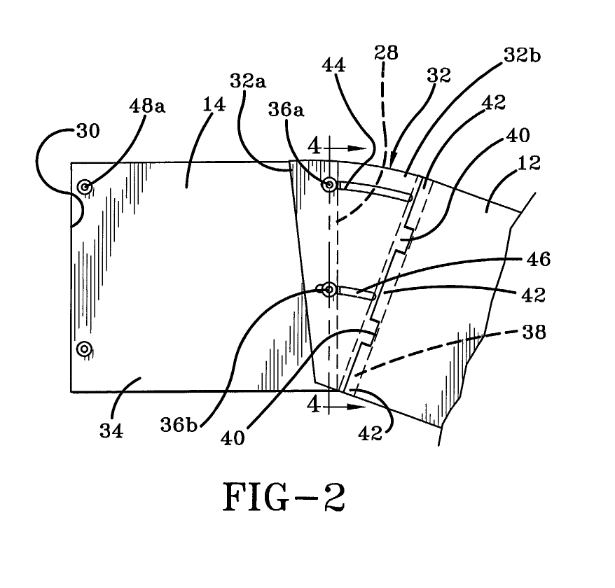

Supporting structure 32 also includes upper and lower slots 44, 46. Slots 44 and 46 may be equal in the length, or upper slot 44 may be longer than lower slot 46, or lower slot 46 may be longer than upper slot 44. Supporting structure 32 may be planar or slightly arced to allow for pivoting of screens 14, 16 relative to central screen 12 without departing from the spirit of the present invention. Similarly, slots 44 and 46 may be straight or an arc without departing from the spirit of the present invention. First screen 14 is arcuately movable toward and away from central screen 12 by means of bolts 36a, 36 slidingly engaging in slots 44, 46. As may be seen from FIG. 2, upper slot 44 is longer than lower slots 46. This allows lateral screen 14 to be moved outwardly and downwardly in the direction of arrow A (FIG. 1). First screen 14 may therefore be moved toward and away from first side 22 of central screen 12. If it is desired to lock first screen in any particular position, bolts 36a, 36b need merely be tightened to the point that they no longer allow for sliding engagement with arcuate slots 44, 46.

For some applications, it may be desirable to have lateral screen 14 move outwardly and upwardly (not shown). In this instance, supporting structure 32 may be installed at 180 degrees to the manner shown in FIG. 2 so that lower slot 46 lies above upper slot 44. Additionally, bolts 48a, 48b are provided on the outer lateral side 30 of lateral screen 14. This allows the user to reposition the first screen 14 on the opposing side of central screen 12.

While FIG. 2 illustrates that bolts 36a, 36b and 48a, 48b are mounted on first screen 14 and hinges 40, 42 are formed on central screen 12, it will be understood by those skilled in the art that the bolts may be mounted on central screen 12 and the hinges 40, 42 may be formed on first screen 14 without departing from the scope of this invention.

System 10 also includes a second lateral screen 16 mounted adjacent second side 22 of central screen 12. Second screen 16 has a width 26 that is preferably substantially the same as that of central screen 12 and/or first screen 14. Second screen has an inner lateral edge 50 and an outer lateral edge 52. The back (not shown) of inner lateral edge 50 is fixed to a first end 54a of an arc-shaped supporting structure 54 by means of a pair of bolts (not shown). The second end 54b includes at least one fourth hinge cylinder 58. Fourth hinge cylinders 58 are pivotally connected to third hinge cylinders 60 on second side 24 of central screen 12 by an elongated rod 56. Arcuate slots 62, 64 are provided on supporting structure 54 and the bolts (not shown) on the back (not shown) of second screen 16 slidingly engage in slots 62, 64 to allow second screen 16 to be arcuately movable toward and away from second lateral side 24 of central screen 12. Once again, the position of second screen 16 may be fixed relative to central screen 12 by simply tightening the bolts on the back of second screen 16 so that they no longer allow for sliding engagement with slots 62, 64. Similarly, all other adaptations of first screen 14 apply to second screen 16.

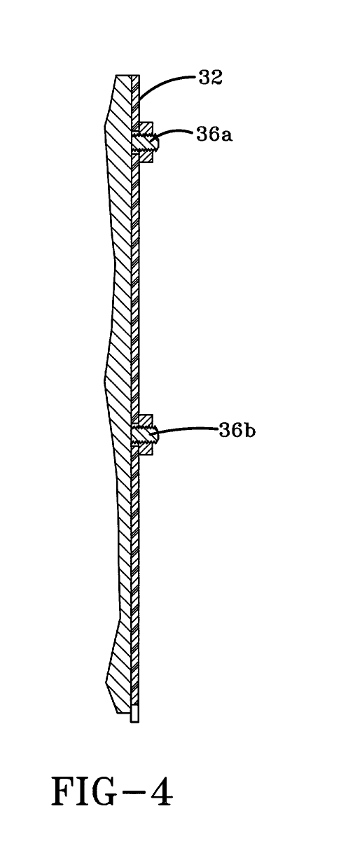

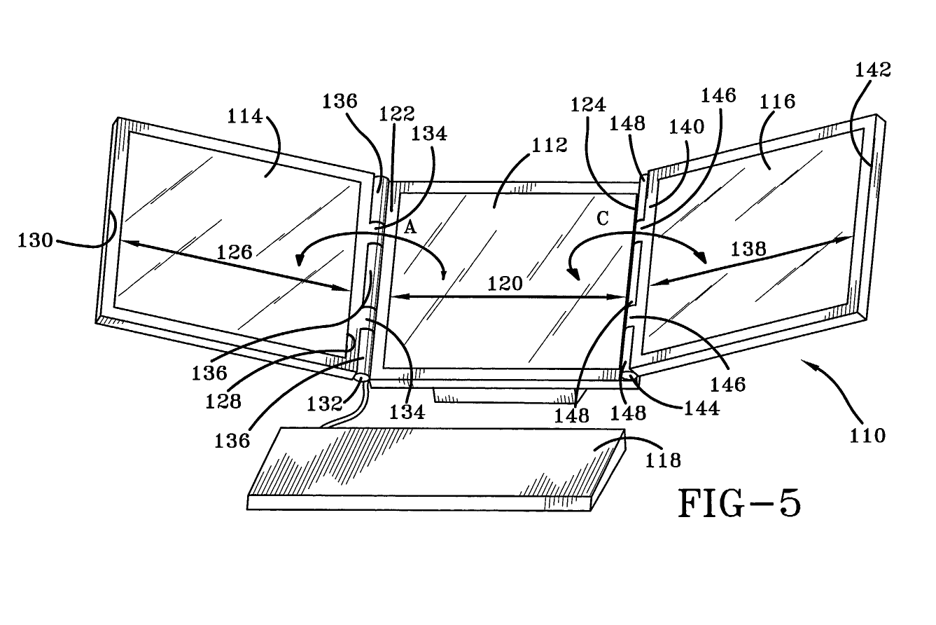

Referring to FIGS. 5-7, there is shown a second embodiment of the present invention. Computer system, generally shown by the number 110, includes a central screen 112, a first screen 114, a second lateral screen 116 and a keyboard or input device 118. As with the first embodiment, input device 118 is shown in FIGS. 5-7 as separate from central screen 112, but, it may be hingedly connected to central screen 112 or may be in any other suitable relationship to central screen 112.

Central screen 112 has a 120 and first and second lateral sides 122 and 124. First and second sides 122, 124 may be formed with first and third hinge cylinders 136, 148 respectively.

First lateral screen 114 lays adjacent lateral side 122 of central screen 112. First screen 114 has a width 126 that is substantially approximately equal in width to central screen 112. First screen 114 has an inner lateral side 128 and an outer lateral side 130. Inner lateral side 128 may be formed with at least a second hinge cylinder 134 therein. In this embodiment, first and second hinge cylinders 136, 134 are pivotally connected together by an elongated rod 132.

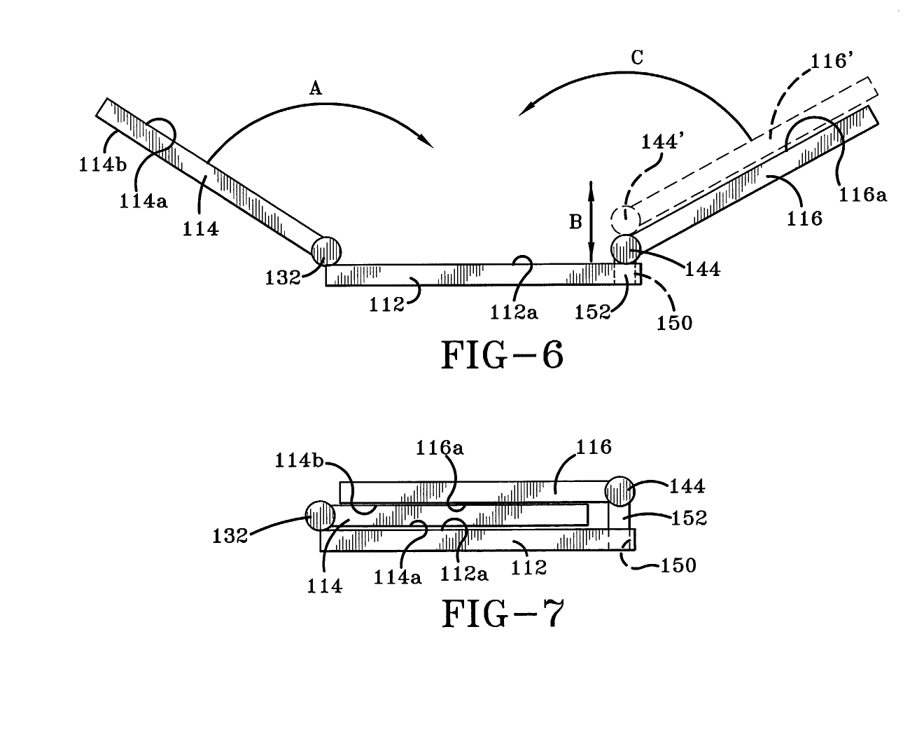

Second lateral screen 116 is connected to the other lateral side 124 of central screen 112 in opposed relation to first screen 114. Second screen has a width 138 that is substantially the same as the width of central screen 112 and/or first screen 114. Second screen 116 has an inner lateral edge 140 and an outer lateral edge 142. Inner lateral edge 140 may be formed with at least one fourth hinge cylinder 146 therein. Second screen 116 is pivotally connected to central screen 112 by an elongated rod 144 being passed through third and fourth hinge cylinders 148, 146 as described hereafter. As shown in FIGS. 6 and 7, lateral side 124 of central screen 112 defines a plurality of bores 150. A plurality of pegs 152 are moveably retained in bores 150 to allow for axial movement of pegs 152 within bores 150. Third hinge cylinders 148 are mounted on pegs 152. Elongated rod 144, third and fourth hinge cylinders 148, 146 and second screen 116 may therefore be moved outwardly and away from central screen 112 to positions 144′ and 116′ respectively (FIG. 6). First screen can thereafter be moved in an arc in the direction of arrow A (FIG. 6) and pivoted inwardly until it lies directly over central screen 112 (FIG. 5). Second screen 116 is pulled upwardly away from central screen 112 in the direction of arrow B (FIG. 4) until is lies in the position 116′. Second screen 116 is then rotated inwardly in an arc in the direction of arrow C (FIG. 6) until it lies directly over first screen 114 (FIG. 5). In this position the front 116a of second screen 116 lays adjacent the back 114b of first screen 114. The front 114a of first screen 114 lays adjacent to the front 112a of central screen 112. The three screens 112, 114, 116 may be folded in this manner when the user desires to stop using the computer or to put it away for easy storage.

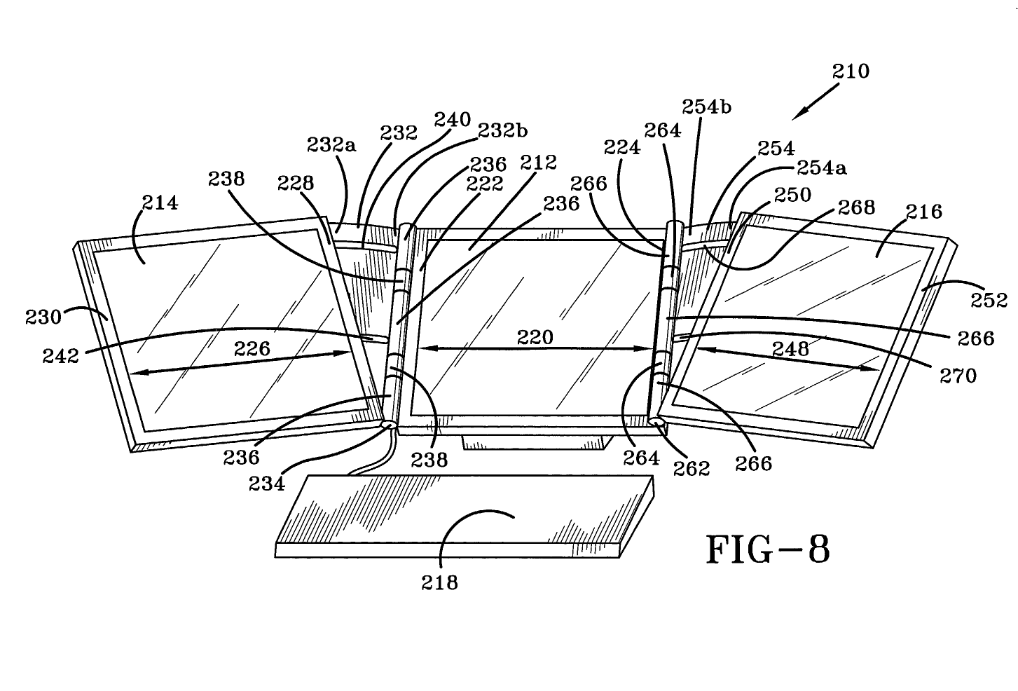

A third embodiment of the present invention is shown in FIGS. 8-10. In this embodiment a computer system, generally referred to by the number 210, includes a central screen 212, a first screen 214, a second screen 216 and a keyboard or input device 218. As before, input device 218 is shown as being detached from central screen 212, but, it may be hinged to central screen 212 as in a laptop computer or attached to the same in any other suitable manner.

Central screen 212 has a width 220 and first and second sides 222 and 224. First and second sides are preferably formed with first and third hinge cylinders 236, 266 respectively.

First lateral screen 214 has a 226, an inner first side 228 and an outer lateral side 230. First screen 214 preferably has a width 226 that is approximately the same as width 220 of central screen 212. Between first screen 214 and central screen 212 there is an arc-shaped support structure 232. Support structure 232 has first and second ends 232a, 232b. Second end 232b has at least a second hinge cylinder 238 formed therein. First end 232a is connected to the back 214b of first screen 214. Support structure 232 is pivotally mounted at its other end to central screen 212 by means of an elongated rod 234 that engages in first and second hinge cylinders 236, 238. Support structure 232 includes arcuate upper and lower slots 240, 242. First screen 214 is arcuately movable toward and away from central screen 212 by means of bolts 244 (FIG. 9) engaging in slots 240, 242 in a manner similar to the interaction shown in FIG. 2. Similarly, bolts 246 are provided proximate outer lateral side 230 of first screen 214 in the event that the user desires to swap the position of first and second screens 214, 216 with each other. As described with respect to the first embodiment, upper slot 240 is longer than lower slot 242. As with the first embodiment, if the user desires to lock first screen 214 into a particular position, bolts 244 simply need to be tightened so that they no longer slide along slots 240, 242. If the user desires to adjust first screen 214 in an opposite direction so that first screen 214 may move upwardly and away from central screen instead of downwardly and away from central screen 214, support structure 232 may be detached and turned through 180 degrees so that shorter, lower slot 242 lies above longer slot 240.

Second screen 216 has a 248 and an inner lateral edge 250 and outer lateral side 252. Second screen 216 has a width 248 that is approximately equal to the width 220 of central screen 212 and/or first screen 214. At its inner lateral edge 250, second screen 216 is connected to a first end 254a of an arc-shaped support structure 254 by bolts 256. Second end 254b of support structure 254 is preferably formed into fourth hinge cylinders 264. First side 224 of central screen 212 defines at least one bore 258, and preferably a plurality of bores 258. Axially movable pegs 260 are received within bores 258. Third hinge cylinders 266 are mounted on pegs 260. An elongated rod 262 connects third and fourth hinge cylinders 266, 264 together. Support structure 254 also includes arcuate upper and lower slots 268, 270 and bolts 256 are slidably engageable with slots 268, 270 to allow for adjustment of second screen 216 with respect to central screen 212 as previously described with respect to the first embodiment (FIG. 1). A second set of bolts 270 are provided proximate outer lateral edge 252 of second screen 216 so that first and second screens 214, 216 may be moved to opposite sides of central screen 212.

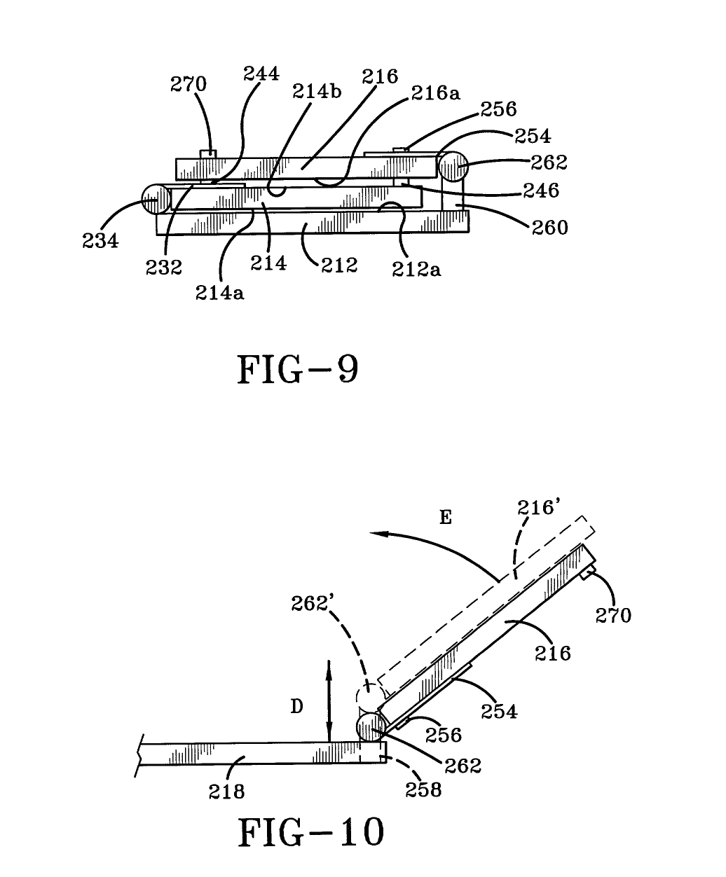

If the user desires to fold up the third embodiment of computer system 210, bolts 244 are loosened so that first screen 14 may be moved relative to central screen 212. First screen 214 is moved toward central screen 212 until inner lateral side 238 abuts elongated rod 234. Outer lateral side 230 of first screen 214 is moved upwardly until first screen 214 has been rotated into abutment with central screen 212. In this position, front face 214a of first side 214 lies in close proximity to front face 212a of central screen 212 (FIG. 9). Second screen 216 is then lifted outwardly away from central screen 212 in the direction of arrow D (FIG. 10) until elongated rod 262 lies in the position indicated by 262′ and second screen lies in the position indicated by 216′. Second lateral screen 216 is then rotated upwardly and inwardly in the direction of arrow E until the front face 216a of second screen 216 lies in close proximity with the back 214b of first screen 214 (FIG. 9). In order to unfold the screens 212, 214, 216, the order of operation need simply be reversed.

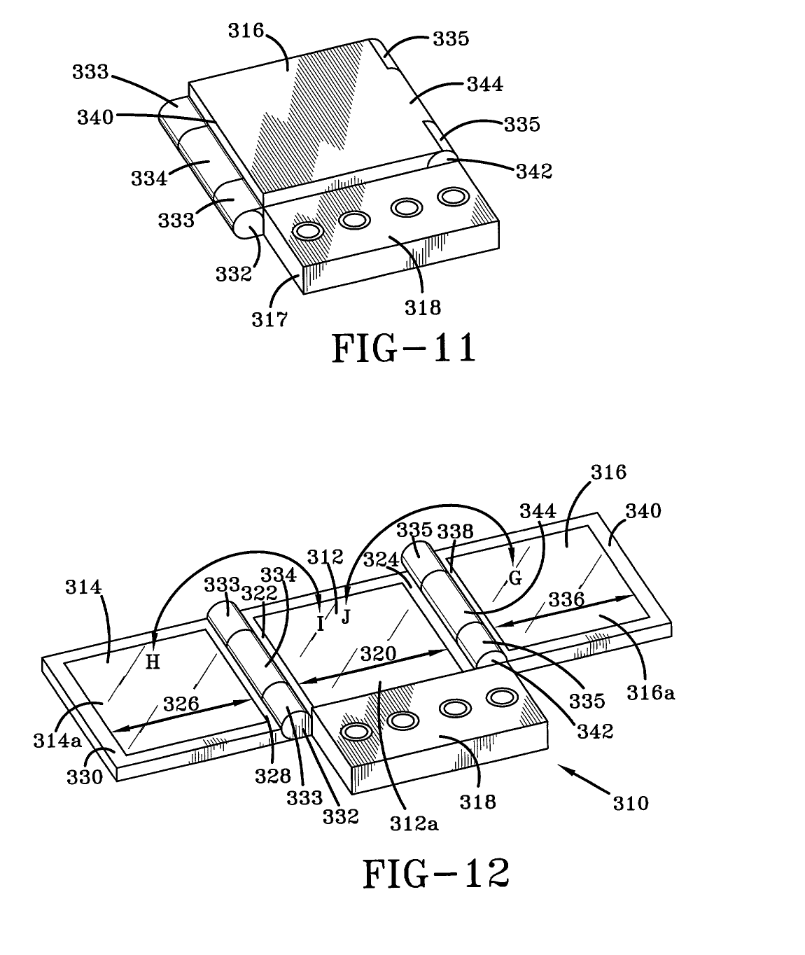

A fourth embodiment of the present invention is shown in FIGS. 11 and 12. In this embodiment, a device 310, such as a personal data assistant, hand-held cell-phone or game machine is illustrated. Device 310 includes a central screen 312, a first screen 314, a second screen 316 and a keypad 318 is shown. Device 310 includes an information storage unit 317 that sends video signals to central screen 312. First and second screens 314, 316 are connected to central screen 312 and are adapted to receive video input from one of said information storage unit 317 and central screen 312.

Central screen 312 has a width 320 and first and second lateral sides 322 and 324. First and second sides include at least a first and a third hinge cylinder 333, 335 respectively.

First lateral screen 314 has a width 326 that is preferably substantially the same as the width 320 of central screen 312. Central screen 312 is sized to be received in a shirt pocket. First screen 314 has an inner lateral side 328 and an outer lateral side 330. Inner lateral side 328 includes at least a second hinge cylinder 334 and is connected to first side 322 of central screen by an elongated rod 332 being passed through first and second hinge cylinders 333, 334 as previously described with other embodiments of this invention.

Second lateral screen 316 has a width 336, inner lateral edge 338 and outer lateral edge 340. Again, width 336 is preferably approximately the same as the width 320 of central screen 312 and/or width 326 of first screen 314. Inner lateral edge 338 of second lateral screen 316 includes at least a fourth hinge cylinder 344. Second lateral screen 316 is connected to second side 324 of central screen 312 by an elongated rod 342 being passed through third and fourth hinge cylinders 335, 344 as described with other embodiments of the invention.

If the user desires to open up first and second screens 314, 316 of the device 310 when it is in the position shown in FIG. 11, they grasp outer lateral edge 340 of second side 316 and move second side 316 in the direction of arrow G (FIG. 12). The user then grasps outer lateral side 330 of first screen 314 and moves it in the direction of arrow H (FIG. 12). The user may then operate device 310. When they wish to put device 310 away, they grasp the outer lateral side 330 of first screen 314 and move it in the direction of arrow I, thereby moving first screen 314 toward central screen 312. First screen 314 comes to rest so that front face 314a lies proximate front face 312a of central screen 312. The user then grasps outer lateral edge 340 of second screen 316 and moves it in the direction of arrow J so that front face 316a comes to rest proximate rear face (not shown) of first screen 314.

While the forth embodiment of the present invention has been shown with butt hinges being used to connect first and second screens 314, 316 to central screen 312, it will be understood by those skilled in the art that device 310 may include the connection means of the other embodiments instead or any other suitable connection means. Consequently, device 310 may include an arc-shaped support structure (not shown) on one or both sides of central screen 312, or it may include the use of pegs (not shown) mounted in bores (not shown) to allow either/both of first and second screens 314, 316 to be lifted upwardly to allow for easier folding and overlap of first and second screens 314, 316.

First screen 314 may therefore be folded over central screen 312 and second screen 316 may be folded over first screen 314 to form the compact unit 310 as is shown in FIG. 11, or the folding of first and second screens 314, 316 may be reversed to form the open unit 310 as is shown in FIG. 12.

As will be understood by those skilled in the art, it is not necessary that the left-hand screen, i.e., the first screen of the above-described embodiments, be folded down over the central screen first. The right-hand screen, i.e., the second screen of the above described embodiments may be folded down over the central screen before the first screen.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A display screen for receiving video input, said display screen comprising:
a central screen having a first width and opposing first and second sides;
a first lateral screen having a second width and inner and outer lateral sides, said inner side being connected to the first side of said central screen by a first pivotal connection;
wherein said first screen is adjustable relative to said central screen at the first pivotal connection.

2. A display screen as defined in claim 1, further comprising a second lateral screen having a third width and inner and outer lateral edges, said inner edge being connected to the second side of said central screen by a second pivotal connection;
wherein said second screen is adjustable relative to said central screen at the second pivotal connection.

3. A display screen as defined in claim 2, wherein one of the first and second screens is foldable over substantially the entire width of said central screen, and the other of said first and second screens is foldable over substantially the entire width of said central screen and lateral screen combination so as to form a compact unit for storage; and said compact unit may be reopened for use by unfolding the first and second screens from over said central screen.

4. A display screen as defined in claim 3, wherein the first pivotal connection comprises:
at least a first hinge cylinder formed on the first side of said central screen;
at least a second hinge cylinder formed on the inner lateral side of said first screen;
a first elongated rod being passed through said first and second hinge cylinders; and
the second pivotal connection comprises:
at least a third hinge cylinder formed on the second side of said central screen;
at least a forth hinge cylinder formed on the proximate side of said second screen;
a second elongated rod being passed through said third and fourth hinge cylinders.

5. A display screen as defined in claim 1, wherein the first pivotal connection comprises:
at least a first hinge cylinder disposed on the first side of said central screen;
a first supporting structure having a first end and a second end, the first end being releasably connected to the inner lateral side of the first screen; the second end having at least a second hinge cylinder disposed thereon;
an elongated rod receivable through the first and second hinge cylinders.

6. A display screen as defined in claim 5, wherein the first side of central screen defines at least one bore, and the display screen further comprises:
at least one peg movably received within the bore and being adapted for axial movement within the bore; wherein said second hinge is mounted on said peg.

7. A display screen as defined in claim 5, wherein the first end of said first supporting structure is connected to the inner lateral side of the first screen by a plurality of bolts.

8. A display screen as defined in claim 7, wherein said first supporting structure defines two vertically spaced-apart slots, whereby the bolts engage the first screen through the slots and whereby the position of the first screen relative to the central screen can be adjusted by allowing the bolts to slidably engage the slots.

9. A display screen as defined in claim 8, wherein there is an upper slot and a lower slot and the upper slot has a greater length than the lower slot.

10. A display screen as defined in claim 8, wherein there is an upper slot and a lower slot and the upper and lower slots are of equal length.

11. A display screen as defined in claim 8, further comprising:
a second lateral screen having a third width and inner and outer lateral edges, said inner edge being connected to the second side of said central screen by a second pivotal connection, wherein said second pivotal connection comprises:
at least a third hinge cylinder disposed on the second side of said central screen;
a second supporting structure having a first end and a second end, the first end being releasably connected to the inner lateral edge of the second screen; the second end having at least a forth hinge cylinder disposed thereon;
a second elongated rod receivable through the third and fourth hinge cylinders.

12. A display screen as defined in claim 11, wherein the second lateral side of central screen defines a least one bore, and the display screen further comprises:
at least one peg movably received within the bore and being adapted for axial movement within the bore, wherein said third hinge is mounted on said peg.

13. A display screen as defined in claim 11, wherein one of the first and second supporting structures is planar.

14. A display screen as defined in claim 11, wherein one of said first and second supporting structures is arcuate.

15. A display screen as defined in claim 11, wherein the first end of said second supporting structure is connected to the inner lateral edge of the second screen by a plurality of bolts.

16. A display screen as defined in claim 15, wherein the second supporting structure defines two vertically spaced-apart slots, whereby the bolts engage the second screen through the slots and whereby the position of the second screen relative to the central screen can be adjusted by allowing the bolts to slidably engage the slots.

17. A display screen as defined in claim 16, wherein there is an upper slot and a lower slot and the upper slot has a greater length than the lower slot.

18. A display screen as defined in claim 16, wherein there is an upper slot and a lower slot and the upper slot and lower slot are of equal length.

19. A display screen as defined in claim 1, wherein a touch pad is positioned beneath one of the central screen and first lateral screen.

20. A display screen as defined in claim 19, wherein said central screen is sized to be received in a shirt pocket.

21. A display screen as defined in claim 8, wherein a touch pad is positioned beneath one of the central screen and first lateral screen.

22. A display screen as defined in claim 21, wherein said central screen is sized to be received in a shirt pocket.
